(19) United States
(12) Patent Application Publication
(10) Pub. No.: US 2026/0008551 A1
(43) Pub. Date: Jan. 8, 2026

(54) AIRCRAFT PROPULSION SYSTEM AND METHOD

(71) Applicant: GKN AEROSPACE SERVICES LIMITED, Solihull (GB)

(72) Inventors: Nathaniel Palmer, Solihull (GB); Stephen Harrison, Solihull (GB); Simon Taylor, Solihull (GB); Joseph Stonham, Solihull (GB)

(21) Appl. No.: 18/881,734

(22) PCT Filed: Jul. 5, 2023
(86) PCT No.: PCT/GB2023/051778

§ 371 Date: Jan. 7, 2025

(30) Foreign Application Priority Data
Jul. 8, 2022 (GB) 2210067.1

(51) Int. Cl. B64D 27/33; B64D 27/355; B64D 37/30; F02C 3/22

(52) U.S. Cl. CPC B64D 27/33; B64D 27/355; F02C 3/22; B64D 37/30; F05D 2220/323; F05D 2220/76

(57) ABSTRACT

The present invention relates to a propulsion system for providing controllable propulsion comprising: a fuel cell arrangement (210) for generating electrical energy; a gas generator (250) comprising a compressor (256), a combustor (254) and a turbine (252), wherein the output from turbine is arranged to provide propulsion from rotational movement; a hydrogen source (212) for providing hydrogen to the fuel cell arrangement and the gas generator; an oxygen source (214) for providing oxygen to the gas generator (250), wherein, in use, the gas generator is used selectively to provide electrical energy for additional propulsion.

### TECHNICAL FIELD

The present invention is concerned with aircraft propulsion systems and power systems. In particular, to aircraft propulsion arrangements which are able to provide a controllably variable level of power and, therefore, thrust at different pressure levels. Different levels of thrust may be delivered to an aircraft based on the specific stage of flight as the stage of flight relates to the pressure experienced by the thrust generating portions of the aircraft. Pressure differences can cause complications in the delivery of power or thrust within an aircraft.

Aircraft gas turbine systems typically provide in the region of 50% of their ground static propulsive power (power required to provide thrust force) at top of climb conditions but around 100% during take off. As such, there is a difference between the power that is to be delivered by an aircraft propulsion system during different stages of flight of an aircraft.

Typically, gas turbines operate well in this aspect as both the thrust lapse of a gas turbine engine and therefore the ratio of thrust to power of take off and top of climb are generally well suited to the inherent properties of a gas turbine. Further, the high specific power afforded by larger and fewer gas turbines leads to little competition from other propulsion architectures due to economic considerations. Therefore, modern systems favour the gas turbine for aircraft propulsion arrangements.

Drawbacks to gas turbine engines include environmental demands, however to date no serious alternatives to the gas turbine engine exist that are able to provide varying thrust in the same manner at similar economic considerations. As such, the gas turbine is the preferred and de facto option for use in aircraft.

Although hydrogen fuels and hydrogen synthetic fuels (synfuels) are occasionally used in aircraft, this is not regularly the case in larger aircraft and not at all in passenger aircraft. This is by virtue of the specific power that can be provided by gas turbines in comparison to that provided by hydrogen systems. Gas turbines can achieve around 5 to 8 kW/kg for a typical system, while hydrogen fuel cell systems can achieve around 1 kW/kg. As such, hydrogen is a reasonable, and an environmentally conscious, choice for smaller aircraft but all but entirely prevented from use in commercial, larger systems.

Fuel cells using hydrogen are under investigation, e.g. Polymer Exchange Membrane (PEM), and recent work has indicated that the specific power value for such systems may optimistically reach 2 kW/kg in the next 5 to 10 years. Some other work has noted that there may be an absolute maximum value of around 1.8 kW/kg. As such, it appears that these systems could not be feasible for use in commercial, passenger aircraft without significant economic drawbacks.

Fuel cells can be operated in an overrated function to provide around 25% greater output for a small amount of time. This figure is higher at the start of life for fuel cells but degrades towards the end of life. Due to the mechanics of overrating, damage may be done to the fuel cell if overrated for long periods and will anyhow lead to degradation of life of the fuel cell. Even using this method, however, clearly the significant difference between take off thrust and top of climb thrust cannot be accounted for in a fuel cell propulsion system.

Aircraft therefore typically require around twice the power during takeoff and climb compared to cruise. This take off and climb phase can last around 5-20 minutes compared to the more than 1 (and up to more than 12) hours of flight time. The total duration of max power within a flight is approximately 5 to 30 mins. The duration from takeoff to cruise altitude transition is of the order of <300 s for peak power. The remaining peak power is a risk contingency for go arounds (during pre-landing phases) and deviation to another airport. The current state of the art arrangements contain such remaining peak power for around three go arounds and one deviation to another airport.

To preserve hydrogen fuel typically fuel cell systems are designed to consume hydrogen and to lead to a waste of air (and therefore of oxygen) of up to 50%. Although this may benefit low quality heat dissipation because of the reaction into the air, it requires greater compression power (nearly double) and therefore increases the parasitic losses where compression is between 15-45% of the fuel cell power and the most significant parasitic power loss. Considerations regarding the cathode size of the stack takes into account the needed rate of oxygen reaction, whereby the O2 is approximately 20% of atmospheric air.

Oxygen may be used in a fuel cell however, oxygen is 8 times the mass of hydrogen and is needed in a ratio of 4:1 (for H2O). As such, carrying oxygen onboard the aircraft is not seen as effective for flight.

Two stage compression has been used for achieving the high pressure ratio required for operating fuel cells at altitude, however when operating a fuel cell at low altitude and at high altitude where low and high pressure ratios are required respectively, it may not be efficient to operate in a fixed configuration. Therefore, consideration regarding use of a fuel cell across a range of altitude conditions and delivery of the requisite airflow to achieve suitable power for different stages of flight is required.

Therefore, there are developments that can be made in this field and advantages that can be obtained from these developments. The inventors of an invention described herein have however created an alternative propulsion arrangement which has a wide range of previously unavailable advantages as described herein.

### SUMMARY OF THE INVENTION

Aspects of the invention are set out in the accompanying claims.

Viewed from first aspect there is provided a propulsion system for providing controllable propulsion comprising: a fuel cell arrangement for generating electrical energy; a gas generator comprising a compressor, a combustor and a turbine, wherein the output from turbine is arranged to provide propulsion from rotational movement; a hydrogen source for providing hydrogen to the fuel cell arrangement and the gas generator; an oxygen source for providing oxygen to the gas generator, wherein, in use, the gas generator is used selectively to provide electrical energy for additional propulsion.

This arrangement provides a reliable propulsion system that can selectively provide a thrust boost when required. The arrangement can be optimised for boost at specific conditions such that highly effective thrust can be provided to the propulsion system when required. Such an arrangement can be used as a highly effective range extender with a reduced environmental impact.

In an example, there is provided a propulsion system wherein the oxygen source is further arranged to provide oxygen to the fuel cell arrangement. Use of the oxygen source improves the electrical efficiency of the fuel cell thereby improving the overall electrical output of the arrangement.

In an example, there is provided a propulsion system, further comprising: a motor/generator connected to the gas generator; a rectifier electrically connected to the motor/generator; a propeller for providing propulsion from rotational movement; an inverter electrically connected to the rectifier and the propeller; and, an electrical bus electrically connecting the rectifier and the inverter, arranged so that the electrical output of the motor/generator connected to the gas generator is converted by the rectifier then converted by the inverter prior to being provided to the propeller

This arrangement provides further electrical efficiency gains from highly efficient electrical transfer within the arrangement.

In an example, there is provided a propulsion system further comprising a converter electrically connected to the electrical bus and to the fuel cell arrangement, the converter arranged to convert the electrical output of the fuel cell arrangement prior to the electrical output of the fuel cell arrangement being received by the inverter.

This arrangement provides dual electrical outputs that in turn enables resilience in the system and indirectly assists in providing a controllable two-source or one-source application for thrust. The arrangement provides greater control for a user in the selective operation of thrust producing components of the arrangement.

In an example, there is provided a propulsion system, further comprising electrical energy storage electrically connected to the fuel cell arrangement and the gas generator, the electrical energy storage arranged to store electrical energy output by the gas generator and the fuel cell arrangement.

This arrangement provides an ability to retain some electrical power when desired. The user is provided with a further level of control over the system. The user can optimise the use of the stored electrical energy, for example during a period where additional thrust (or range) is required from the propulsion system.

In an example, there is provided a propulsion system further comprising: a water arrangement for providing fluid communication of water between a water store and the fuel cell arrangement and the gas generator; and, an air arrangement for providing fluid communication of air between an air inlet and the fuel cell arrangement and the gas generator.

This arrangement provides a reliable transmission of air for use as fuel and water for cooling.

In an example, there is provided a propulsion system according to any of claims 1 to 6, wherein the hydrogen source and oxygen source are in a closed loop system within the propulsion system.

This arrangement provides further electrical efficiencies and overcomes issues experienced using ambient air supplies in relation to partial pressure drop.

In an example, there is provided an aircraft comprising the propulsion system described above.

In an example, there is provided an electric power range extender for providing electrical energy comprising: a gas generator; a hydrogen source for providing hydrogen to the gas generator; and, an oxygen source for providing oxygen to the gas generator, the gas generator being arranged in use to selectively use hydrogen and oxygen from the hydrogen source and the oxygen source to generate electrical energy.

This arrangement provides an effective, highly efficient range extender which also avoids using fuels that result in undesirable green house gas exhaust components. Specifically, the present invention provides a solution that utilises renewable and clean fuels while providing a significantly increase of the range of such electrically driven vehicles. Such an arrangement renders more viable for longer term commercial use of clean transport, particularly in aerospace. Furthermore, this arrangement provides more efficient electrical transfer due to conversion of the electricity prior to transmittal.)

In an example, there is provided an electric power range extender further comprising electrical energy storage electrically connected to the gas generator, the electrical energy storage arranged to store electrical energy output by the gas generator.

This arrangement provides an ability to retain some electrical power when desired. The user is provided with a further level of control over the system. The user can optimise the use of the stored electrical energy, for example during a period where additional thrust (or range) is required from the propulsion system.

In an example, there is provided an electric power range extender wherein the hydrogen source and oxygen source are in a closed loop system within the electric power range extender.

This arrangement provides further electrical efficiencies and overcomes issues experienced using ambient air supplies in relation to partial pressure drop.

In an example, there is provided an electric power range extender further configured to connect to an aircraft propulsion system.

This arrangement provides a “plug and play” solution for improving the range of an aircraft propulsion system, particularly one wherein electrical energy generation is already performed using cryogens.

In an example, there is provided an aircraft comprising the electric power range extender. This arrangement provides a “plug and play” solution for improving the range of an aircraft, particularly one wherein electrical energy generation is already performed using cryogens.

Viewed from another aspect there is provided a method of generating propulsion comprising: providing hydrogen from a hydrogen source to a fuel cell arrangement to produce an electrical energy output; providing the electrical energy output of the fuel cell arrangement to a propeller to generate propulsion; selectively providing hydrogen from a hydrogen source and oxygen from an oxygen source to a gas generator to selectively produce an electrical energy output; selectively providing the electrical energy output of the gas generator to a propeller to generate propulsion

This arrangement provides a reliable propulsion generation method that can selectively provide a thrust boost when required. The method can be optimised for boost at specific conditions such that highly effective thrust can be provided when required. Such a method can be used as a highly effective range extender with a reduced environmental impact.

In an example, there is provided a method of generating propulsion further comprising: selectively providing hydrogen from a hydrogen source and oxygen from an oxygen source to a gas generator based on a predetermined propulsion-requiring travel condition.

This arrangement provides thrust boost when it is required, specifically at a predetermined and calculated point of requirement. The thrust provision can therefore be optimised for that specific point of requirement and therefore provide an extremely effective boost in light of the predetermined travel conditions. Such a method may take account of travel velocity, atmospheric conditions and the like and provide an optimised thrust output.

In an example, there is provided a method of generating propulsion wherein the predetermined propulsion-requiring travel condition is take off and climb portion of a flight of an aircraft.

This arrangement provides thrust boost at specific travel conditions. The boost can therefore be tailored to provide a thrust that is highly effective at the point of requirement, specifically at the point of most thrust requirement such as take off and climb.

In an example, there is provided a method of generating propulsion, further comprising: selectively providing hydrogen from the hydrogen source and oxygen from the oxygen source to the gas generator to selectively produce an electrical energy output based on a predetermined non-propulsion-requiring travel condition; wherein the electrical energy output of the gas generator is provided to electrical energy storage for storage

This arrangement provides a condition in which electrical energy is not required for thrust but where energy can be provided and stored in advance of a requirement for electrical energy. For example, in low thrust requirement conditions, such as at level travel (e.g. flight), energy could be provided to battery for use in later processes. Such processes may be additional thrust provision or refrigeration or the like on a vehicle (e.g. aircraft).

In an example, there is provided use of any of the above methods in an aircraft.

The methods are particularly advantageous for use in an aircraft where thrust requirements can vary significantly at differing stages of flight.

### BRIEF DESCRIPTION OF THE DRAWINGS

One or more embodiments of the invention will now be described, by way of example only, and with reference to the following figures in which:

FIG. 1 shows a schematic of a fuel cell propulsion system including stacks and turbo compressor; and,

FIG. 2 shows a schematic of a fuel cell propulsion system with a hydrogen-fed fuel cell and an oxygen-and hydrogen-fed gas generator according to an example of the present invention;

FIG. 3 shows a schematic of a fuel cell propulsion system with an oxygen- and hydrogen-fed fuel cell and an oxygen-and hydrogen-fed gas generator according to an example of the present invention; and,

FIG. 4 shows a schematic of a battery electric range extender with a hydrogen- and oxygen-fed gas generator.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”. The invention is further described with reference to the following examples. It will be appreciated that the invention as claimed is not intended to be limited in any way by these examples. It will also be recognised that the invention covers not only individual embodiments but also combination of the embodiments described herein.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the spirit and scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

### DETAILED DESCRIPTION

An invention described herein relates to generating propulsion for an aircraft and power systems. A particular engine system for an aircraft may involve a fuel cell, at least one compressor and at least one turbine. The generation of propulsion is dependent on factors than can be affected by altitude. As such, the aircraft propulsion systems herein are arranged to account for the differing power requirements during different phases of flight as a result of the differing pressures at different altitudes. Additional power may be provided during take off/climb and then not be provided during cruising. The additional power for take off and climb is therefore required at a higher pressure when at ground and at a lower pressure nearing the top of the climb phase.

An invention described herein relates to a battery electric range extender, also referred to as an electric power range extender, for efficient range extension and that has a low environmental impact.

The present invention provides a number of inventive strategies that enable compression and compressed fuels to be used more efficiently in fuel cell propulsion systems. Fuel cells operate by being provided with some portion of hydrogen and some portion of oxygen (e.g. from air) as reactant and oxidant respectively. Fuel cells use these to provide electrical energy. Herein, these are generally referred to as “fuels” provided to fuel cells, i.e. the hydrogen and oxygen are referred to as “fuels”. The term “fuel” as used in the first sense is as reactant, and in the second sense as oxidant. The term is used in general to broadly refer to a matter that is in some way changed in a process that may produce useable energy, such as the conversion of hydrogen and oxygen into water at the release of electrical energy.

Oxygen sources that may provide oxygen for use in a fuel cell propulsion system, for example in an aircraft arrangement, include the environment control system (ECS), obtaining oxygen (O2) via enrichment of ambient air or use of a dedicated (or otherwise) oxygen source. The oxygen source may be a liquid oxygen source (LOx). Advantageously the liquid oxygen is less space intensive than oxygen in a gaseous phase, therefore there are capacity advantages associated with use of LOx in any of the systems described herein. Specifically the volumetric density of LOx is superior to oxygen in gaseous form.

Aircraft often carry on-board oxygen and this is a byproduct of the electrolysis process in the production of hydrogen (H2) from water. Many current aircraft carry on-board oxygen in bottles that can be used in case of cabin depressurisation as might occur from a blown out window or the like. The amount stored is suitable to cover the period until a descent to a safe altitude can be achieved. While passengers use drop down oxygen masks, the crew for example may use portable oxygen bottles. As such, current aircraft often have an oxygen generator or, more commonly, gaseous oxygen tanks onboard.

Additional power may be provided from a fuel cell arrangement through the use of the provision of compressed fuels into the fuel cells. In particular, in compressed oxygen and hydrogen that are subsequently provided to the fuel cell, fuel cell stack or fuel cell array.

Additional power may be provided from a fuel cell arrangement through the use of a control regime wherein oxygen (O2) is utilized and H2 is spent during the process (this H2 may be recirculated back into the system and therefore re-used). An advantage available from this arrangement is related to the benefits in lower mass of H2 being ⅛ of the mass of O2, while being factor ¼ in the reaction to H2O. The volume and mass of H2 is such that a small increase in mass and volume will be comparatively small in the design. Recirculation of H2 is also easier to achieve and beneficial as there is no requirement to deal with oxygen depleted air. A further advantage is that energy is not wasted on compression if the air is released from the aircraft (spilled overboard).

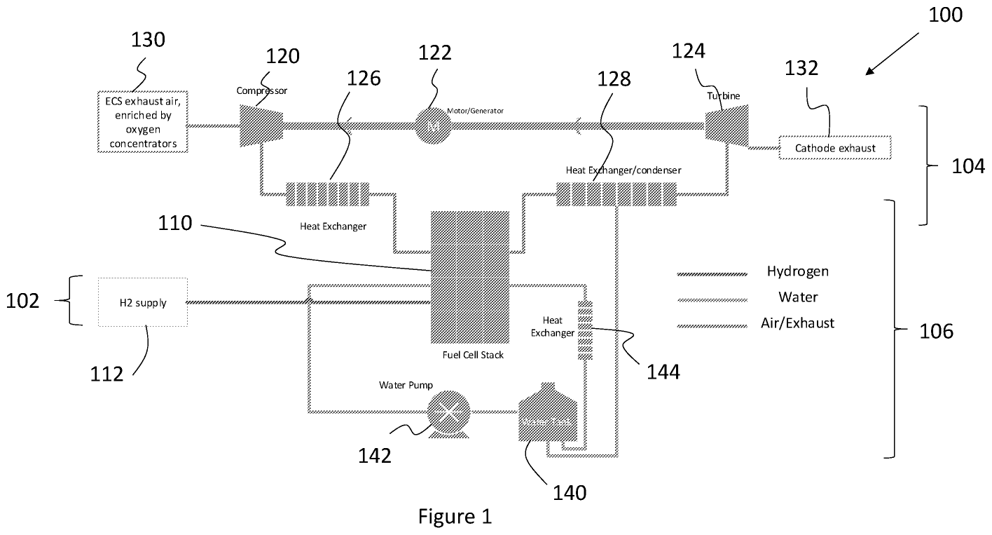

Referring now to FIG. 1, there is shown a propulsion system 100 comprising a fuel cell stack 110. The fuel cell stack 110 is connected to a H2 supply 112 via a H2 supply line. This hydrogen portion of the propulsion system 100 is labelled by portion 102.

While a hydrogen supply will be used throughout the examples shown herein, alternative suitable fuels such as reformed hydrocarbons, or the like, could be used with the proposed propulsion system. The hydrogen supply may comprise 99.99% hydrogen (around 100% or the like) or a lower percentage which would provide a workable fuel in the supply. This may include commercially pure hydrogen which is typically around 99.99%. Alternatively, some fuels may be used with impurities of around 0.4% level, therefore providing a 99.6% hydrogen. Additionally or alternatively, the supply may provide methane at higher percentages alongside converting the methane into hydrogen or alongside use of a methane fuel cell.

The propulsion system 100 has a compressor 120, a motor/generator 122 and a turbine 124. The compressor 120 is connected to a heat exchanger 126 and the turbine 124 is connected to another heat exchanger/condenser 128. The compressor 120 is connected to the ECS exhaust air supply 130. The compressor 120 may be a turbo compressor of a single stage centrifugal type and needs to provide the complete range of pressure ratios for all operation conditions from a pressure ratio of approximately 3 to approximately 9. The system may be an electrically driven compressor 120 and can use a turbine 124 for energy harvesting from the cathode (hot air exhaust) 132.

The ECS exhaust air supply 130 may be enriched by oxygen concentrators. This enrichment may happen before or after the oxygen reaches the air supply 130 in the process. The turbine 124 is connected to the cathode exhaust 132. This air/exhaust portion is labelled by portion 104. Element 130 is referred to as an ECS exhaust air supply but may also be an external (ambient) air supply or the like. The main function of element 130 is to provide air (whether oxygen enriched in some way or not) for use in the fuel cell stack 110, via the single compressor 120 of the system 100.

The two heat exchangers 126, 128 are connected to the fuel cell stack 110. Heat exchanger 126 is connected to compressor 120 and fuel cell stack 110 and cools air exiting from the compressor 120. This heat exchanger 120 may be optional depending on both the temperature limits of the fuel cell stack 110 and the temperature of the air after compression by the compressor 120. The fuel cell stack 110 is connected to a water tank 140 via a water pump 142 and a heat exchanger 144. The water tank 140 is connected to the heat exchanger/condenser 128. This water portion is labelled by portion 106.

The examples shown herein are of a water cooled fuel cell stack system. The examples shown have been simplified to emphasise the most inventive elements of the present system. However, these are merely examples. Such examples may omit in-depth details relating to less prevalent elements in the system, such as optional recirculation systems that might be used to recirculate hydrogen. Other omissions include humidifiers that can be used on the cathode air supply. Therefore, while not explicitly shown, such features can be included in the present arrangement. Furthermore, the present arrangements may be used with evaporative cooled fuel cell stacks.

Indeed, the condensing heat exchanger 128 may be optional for the high power phase with no condense water extracted. Instead, the moist air may be sent overboard (“spilled”) or stored in an intermediate container until it can be sent overboard. In this manner, the pressure loss inherent in the use of the condense heat exchanger 128 would not be included in the arrangement, which leads to a higher performance system (in the form of more power). To compensate for this spilling overboard of moist air, a slightly larger water tank would be required.

In the arrangement shown in FIG. 1, the propulsion system 100 uses ECS air with oxygen concentrators. There are a number of advantages that stem from this arrangement:

The oxygen concentrators (oxygen separators) may be used to produce a higher percentage of O2 in the air in the portion 104 than in the cabin or than in external ambient air. Use of a higher percentage of O2 for a period will enable the fuel cell to operate at a net higher power level during that period. In contrast, systems without an oxygen concentrator use oxygen as contained in ambient air. The result is that many current fuel cell systems waste air and consume H2 to its fullest extent. This is necessary with ambient air as the approximately 21% O2 (as in air) will become depleted and could potentially starve the fuel cell. This is not the case with an oxygen system. O2 in the reactant ratio is 4 times heavier than the H2 and, as such it makes more sense that, if waste is to occur, the H2 is wasted. This is further justified as substantially more H2 is stored than O2 and, as such, the change in mass at system level (tank mass specifically) is lower. Additionally, and beneficially, in the high power case for a cryogenically cooled system this arrangement allows for more available heat dissipation in the liquid hydrogen.

The air source requires less compression than an external ambient air (which, at altitude, can be low). Our estimates show that the compression is around 3 times rather than 9 times which would be required for ambient air. This is because the air source may come from the cabin air, which has already been pressurised, and because the air can be enriched with oxygen. Enrichment with oxygen results in less air being required, and accordingly less compression is required.

Additional advantages can be gained from the lower temperature air in the air source when compared to compressed ambient air. In the arrangement wherein heat exchanger 126 is omitted, there is no pressure loss associated with the inclusion of the heat exchanger 126. Accordingly, the lower air temperature on the cathode side means that the fuel cell stack 110 is able to dissipate more heat into the air before an equivalent stack temperature is reached (equivalent temperature to an arrangement including heat exchanger 126). In this way, the omission of the heat exchanger 126 may be beneficial as enabling operation of the fuel cell stack 110 at a higher power.

The oxygen concentrators can be used so as to increase the O2 ratio within the air supplied in the portion 104 or the oxygen concentrators may be used to supply pure oxygen to the system 100. As previously mentioned, use of higher proportion of O2 in the air supply 130 to the fuel cell stack 110 enables a greater power output from the fuel cell stack 110 as there is less non-reactive air (nitrogen etc) passing through the fuel cell stack 110. Alternatively, a smaller fuel cell stack can be provided which provides the same output power (as a result of the greater per size power output of the present fuel cell stack 110 arrangement).

In the event that liquid oxygen is used from an oxygen supply (such as a tank or the like), the specific heat of vaporization and specific heat capacity of the oxygen can be used to cool elements of the propulsion system 100. Cooling of electrical elements leads to gains in efficiencies die to lack of e.g. eddy currents etc. Furthermore, use of pure oxygen in the system 100 can enable use of a smaller fuel cell area and therefore smaller and lighter stack 110. This leads to efficiency benefits as a result of the mass of the stack that needs to be carried, for example, by an aircraft in use. The lower mass the stack, the less fuel required to account for that mass in comparison to a heavier system.

Liquid oxygen enables an even lower inlet temperature of the oxidant which in turn enables the fuel cell stack 110 to operate at potentially higher heat dissipation and therefore power. Further potential advantages include that, as the only gas content is oxygen this oxygen could be consumed entirely. For an air system, typically only 50% of the oxygen may be consumed as the system has to ensure that the fuel cell stack has sufficient O2, as such an overprovision of O2 is preferred. The current system 100 has a benefit in ensuring less oxygen waste as well as reducing the pressure loss (including back pressure) at the outlet of the stack 110. This will most likely lead to IP in how we get the water of the stack whilst trying to keep the O2 in.

In the example shown in FIG. 1, the fuel cell stack 110 needs to operate well in both the above-described cases as such a more primary advantage relates to increased stack power (prior to accounting for parasitic losses, i.e. turbocompressor, pumps etc.) and net power, rather than a slightly more secondary advantage regarding resizing the stack 110.

By re-using the ECS air via the supply 130, the system 100 has no requirement for an external air intake to bring in air from the surrounding environment. As such, there are aerodynamic drag benefits associated with the omission of an external air intake element. This drag benefit translates to a benefit associated with the energy demand on the system 100 as a whole; it can be understood that the system 100 would need to provide more thrust to accommodate an element that was likely to provide additional drag. By removing the need for this element, the system 100 is more efficient.

As mentioned, this system has a fixed configured which may not be efficient for providing power across a wide range of altitudes and therefore pressures.

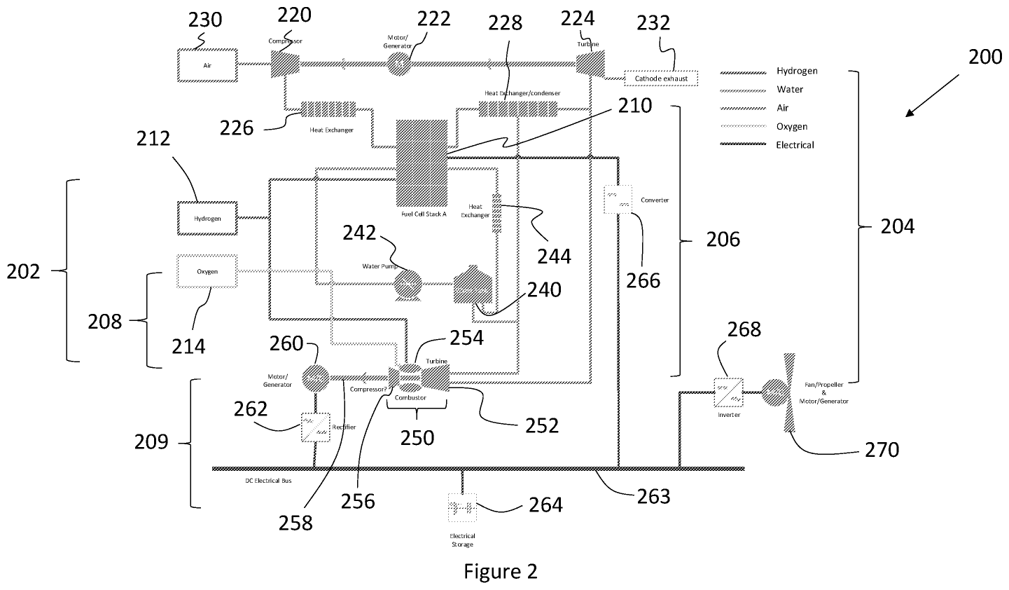

Referring now to FIG. 2, there is shown a fuel cell propulsion system 200 with a hydrogen-fed fuel cell and an oxygen-and hydrogen-fed gas generator 200. Reference numerals for similar components of propulsion system 200 will be those as used in FIG. 1 with the numeral increased by 100. For expediency, a full description of similar components may not be provided.

The propulsion system 200 comprises the arrangement shown in FIG. 1 in the fuel cell stack 210, H2 supply 212, compressor 220, motor/generator 222, turbine 224, heat exchanger 226, heat exchanger/condenser 228, air supply 230, cathode exhaust 232, water tank 240, water pump 242, and heat exchanger 244.

The propulsion system 200 has portions indicating which elements are fed by which sources. In particular, the system 200 has a hydrogen portion 202, an air portion 204, a water portion 206, and an oxygen portion 208. The water and air portions supply water and air, respectively, to the elements as shown previously in FIG. 1 and additionally, in FIG. 2, to the gas generator 250. The gas generator 250 has a turbine 252, a combustor 254 and a compressor 256.

The gas generator 250 may also be referred to as a gas turbine. The gas generator 250 generates rotational power and uses a propulsive motor for converting electricity into motion. The arrangement is combined with the fuel cell for converting hydrogen into electrical energy. The combustor 254 reacts fuel and oxygen and the turbine converts electrical energy into kinetic energy. The compressor 256 may be optional in some arrangements. Fuel and oxygen could instead (or additionally) be provided from a compressed tank or source removing any requirement for a compressor 256.

The hydrogen supply 212 supplies hydrogen to the gas generator 250 and the oxygen source 214 supplies oxygen to the gas generator 250.

In further addition to the arrangement shown in FIG. 1, the system 200 of FIG. 2 has an electrical portion 209 comprising the gas generator 250, a motor/generator 260, a rectifier 262, electrical storage 264, a converter 266, an inverter 268 and a fan/propeller and a motor/generator 270.

The gas generator 250 of the electrical portion 209 is connected to the air portion 204, with air passing from turbine 224 to the turbine 252 of the gas generator 250. The gas generator 250 of the electrical portion 209 is also connected to the water portion 206, with water passing from the heat exchanger/condenser 228 and water tank 240 to the turbine 252. As mentioned above, the gas generator 250 also receives hydrogen and oxygen from the hydrogen supply 212 and the oxygen supply 214 respectively.

The gas generator 250 is connected to the motor/generator 260 via a shaft 258. The motor generator 260 is electrically connected to a rectifier 262. The rectifier 262 converts from AC current to DC current. The rectifier 262 is therefore a type of converter. By converting to DC, electrical efficiencies in distribution are gained.

The rectifier 262 is electrically connected to the DC electrical bus 263. The DC output of the rectifier 262 is therefore carried by the DC electrical bus 263 to other components in the electrical portion 209. The electrical bus 263 connected the rectifier 262 to an electrical storage 264. The electrical storage 264 provides the function of retaining some electrical energy for latter use. The electrical storage 264 may be called electrical energy storage. This can therefore provide control for a user over the timing of use of the electrical energy, such that the energy is only used when required, such as during specific moments in flight. Such storage may be in the form of a battery or the like.

The electrical bus 263 also connects the rectifier and a converter 266 that is connected to the fuel cell stack 210. Therefore, the motor generator 260 and the fuel cell stack 210 output electrical energy which is distributed in as DC by the electrical bus 263. This electrical energy may be stored in electrical storage 264 or be provided to the inverter 268 which is connected to the fan/propeller and motor/generator 270. The inverter 268 converts the electrical energy from DC to AC. This conversion occurs prior to delivery of the electrical energy to the fan/propeller and motor/generator 270. The electrical energy is therefore provided to propulsive motors for generation of thrust by the propulsion system 200.

There are a number of advantages associated with the arrangement shown in system 200, some of which will now be discussed.

There is relatively little, or even in some arrangements no, compression required depending upon the O2 inlet pressure from oxygen supply 214. For the same usable shaft power, a significantly lower compressor ratio is required due to the use of pure O2 (100% O2) compared to atmospheric air (circa. 22% O2) for the same quantity of oxidant. A higher power density can therefore be provided to all other components within the arrangement including the combustor and turbine in gas generator 250. As such, a greater electrical output can be provided.

By virtue of the delivery of hydrogen and oxygen from the hydrogen source 212 and the oxygen source 214 respectively, and the delivery of air and water from the air inlet 230 and water tank 240, the system 200 is effectively a closed loop machine. The inputs are from controlled sources at controlled temperatures, pressures and flow rates. This is therefore an effective use of the resources provided. While not shown, the gas generator 250 may be connected to receive the waste exhaust H2 and/or O2 from the fuel cell stack 210. This additionally improves the use of the resources provided.

The closed loop nature of the arrangement 200 also has benefits in that there are no limitations of the starting/re-lighting envelope when compared to conventional propulsion and APU gas turbines. This aspect is an improvement over systems wherein the APU utilises air from ambient environment. As the aircraft is at altitude, ambient air experiences a pressure drop which can negatively impact the power system. In contrast, by storing hydrogen and oxygen on the aircraft, the impact of low pressure is negated providing the above benefit.

The gas turbine 252 may be designed for utilization from max static power up to transition into high speed cruise with similar compressor inlet 256 and largely controllable turbine 252 outlet conditions. As such, the design range of the system 200 is lower enabling higher performance for utilization. The gas generator 250 may be arranged to provide a greater specific performance for a given range of, e.g., mach power and altitudes. The generator 250 can be arranged to provide a specific power boost in specific conditions thereby providing a very high performance during those conditions, but otherwise not operated and therefore saved for performance in those conditions.

The sources for air, hydrogen, oxygen and water may be reservoirs, tanks or containers or the like. There is no requirement for the inlets to be on an aerodynamic surface of an aircraft or the like. As such, there is no intake drag and inlet energy losses. This leads to improved efficiencies (c.f. fuel consumed) and a lower installed noise footprint. Therefore electrical and environmental advantages are provided the by arrangement 200. The fact that there is no inlet duct reduces aerodynamic noise propagation from this source thereby reducing the forward noise profile of the system 200 when integrated into an aircraft.

Further environmental benefits are provided by the use of pure oxygen from the oxygen source 214, i.e. without nitrogen or other atmospheric gases. The only combustion product from system 200 will be water, with some incomplete combustion products. Therefore, the system 200 is a true zero emission power system.

The hydrogen source 212 and the oxygen source 214 hold liquid hydrogen and oxygen respectively. These cryogens may be used to cryogenically cool the generator and converter elements in the system 200 to a superconducting state. This cooling may occur during peak conditions as the latent heat of vaporization of LH2 alone may not be sufficient. This cooling may be used for cooling the turbomachinery or other thermal sources on the aircraft in which system 200 is arranged. It may also or alternatively be used to force condensing of the exhaust efflux if so required. This can prevent release of exhaust gases, which in turn has a further environmental benefit.

In more detail, in “normal” operation of FIG. 2 cooling may occur using only liquid hydrogen and not liquid oxygen. The generator and converter (and/or similar components) may be cooled by liquid hydrogen. When the arrangement is used in a boost arrangement, thereby generating peak power and high levels of thermal energy, greater cooling may be required. In this instance, the liquid oxygen may be used as a coolant for the generator and converter (and/or similar components).

A further advantage of the power generation system 200 is that heat generated from the propulsion system is dissipated into the exhaust flow reducing the need for heat exchangers which operate less effectively at low speed. This again increases the overall electrical efficiency of the system 200.

The utilization of the gas turbine may be for a specific period of time per flight. In an example, the gas turbine 250 may be used for up to 500 s per flight and perhaps up to 30,000 flight cycles means an operating life in the region of 4,200 flight hours. In other examples, the system may be used up to 3,000 flight hours. As such, the mechanical and chemical fatigue will be less of a challenge compared to a hydrogen gas turbine for primary propulsion. Therefore, there are gains available in terms of resilience of this system over presently known systems. This leads to greater lifetime and greater resilience to degradation when in use.

The system 200 may be integrated with a fuel cell turbo compressor including with a turbine of the turbo compressor enabling significant increase in performance. This may be used with decoupling techniques for efficient power production and power management during flight.

Therefore, the system 200 provides a large number of associated advantages through the interplay of the features within the system 200. Many of these relate to electrical efficiency, which in turn relates to efficiency of generated propulsion and environmental efficiency.

The system 200 may directly drive a fan/propeller or generator, as shown in element 270. This system 200 may be used as a power generation unit and be integrated into a multi-fuel or hydrogen-fuel system with primary propulsion from combustion engines. The option shown in the arrangement of FIG. 2 utilizes a fuel cell stack 210, however this is not a limiting arrangement as explained.

By integrating a fuel cell stack 210 into this system 200, there are benefits in relation to use for cruise power as fuel cells operate better with controlled sources than with high altitude, lower oxygen concentration air. Furthermore, there is an environmentally beneficial contrail performance from this arrangement 200 than over other systems. The dedicated oxygen gas generators may be used to provide additional propulsive energy during periods of express need, such as during takeoff and climb, as explained above. This additional propulsive energy may also be provided by the dedicated oxygen gas generator during aborted landing or other flight deviations as required. The oxygen gas generators, in effect, provide a booster system that is highly electrically efficiency, highly environmentally friendly and relatively easy to integrate into present systems. The solution provided herein is therefore wide reaching in its benefits and effective.

While the arrangement 200 has a large number of features that interrelate to provide advantages as mentioned above, the implementation of the arrangement 200, in a system requiring of propulsion, such as an aircraft, may be controlled to provide additional advantages. For example, a steam turbine could be coupled with a thrust producing exhaust nozzle. The release of exhaust hydrogen and oxygen can be through a nozzle that provides additional thrust for the propulsion arrangement. This improves the efficiency of the overall arrangement in providing thrust. Combusting hydrogen provides higher exhaust temperatures than those produced by the fuel cell 210. Such higher exhaust temperatures may be used to create high exhaust velocities. These exhausts could be implemented around the tail of an aircraft to minimize wake/boundary layer similar to boundary layer ingestion.

The arrangement 200 of FIG. 2 has a fuel cell stack 210. The arrangement 200 also has an oxygen source 214. The arrangement 200 can be used with an additional fuel cell stack. There would then be weight considerations in providing a second fuel cell stack to the system 200 of FIG. 2. If the weight of the second fuel cell stack is too great, this will lead to an inefficient system 200 as the first fuel cell stack 210 will need to provide more power during transport to account for the weight of the second fuel cell stack. As such, the system 200 may be arranged to carry just enough liquid oxygen for around 6 minutes of additional power (provided by an additional fuel cell stack) during takeoff and climb. This can be provided to the additional fuel cell stack from the source 214. In this way, once in cruise, the first fuel cell stack 210 can carry the least amount of additional weight, i.e. only that which is required, thereby ensuring the system 200 is as light as possible. This arrangement, fuel cell stack A 210 with only the required fuel and fuel cell stack without any fuel, is still lighter than two conventional fuel cell systems. As such, the system 200 may be particularly efficient in such an arrangement (with two fuel cell stacks).

The sizes of the fuel cell stacks may not be the same. The stacks can be load balanced so as to best provide power for the specific usage of the system 200. For example, if the system 200 is used in an aircraft, the additional higher operating power fuel cell stack (not shown) may be 50-60% smaller than the fuel cell stack A 210. In this way, the system 200 can be arranged to have minimal impact in terms of space required to house the system 200.

The additional fuel cell stack would therefore not require additional balance of plant, or at least limited additional balance of plant, which, in turn, increases the specific power output. As the stack 110 is around 50-60% mass of the system 100 this could lead to around a >100% increase in total specific power of system 200 (e.g. for a 1.5 kW/kg base system, approx. 3.1-4.1 kW/kg).

A benefit of having the additional fuel cell stack associated exclusively with the oxygen source (i.e. using pure oxygen or very high oxygen percentage air) enables the balance of plant to be kept to a minimum for this stack integration. The additional fuel cell stack will be sufficiently more power dense (approx. 20% cathode volume by oxidant volume for air can become 100%) compared to the baseline case.

Such an arrangement, with an additional fuel cell stack running from the oxygen source, is not shown but is envisaged in the present disclosure.

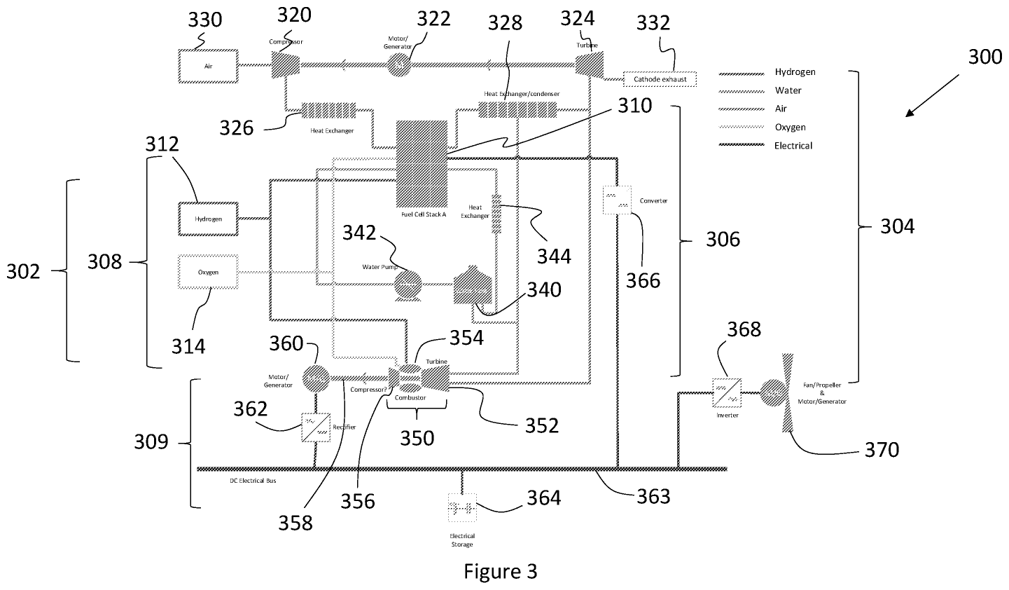

Referring now to FIG. 3, there is shown a propulsion system 300 similar to the propulsion system 200 of FIG. 2. Reference numerals for similar components of propulsion system 300 will be those as used in FIG. 2 with the numeral increased by 100. For expediency, a full description of similar components may not be provided.

In the arrangement of FIG. 3, the oxygen source 314 provides oxygen to the gas generator 350 and the fuel cell stack 310. In FIG. 2, the oxygen source did not feed the fuel cell stack.

The oxygen in the oxygen supply 314 may be liquid oxygen. Use of liquid oxygen has advantages in relation to the volumetric density and energy density of the liquid oxygen. Additional benefits from use of this arrangement 300 may be that the fuel cell stack 310 can be used as a vaporizer to help raise the temperature of the oxygen for input into the fuel cell stack 310. Additionally, the oxygen can be used to cool the coolant (in FIG. 3, from the water arrangement) prior to entry into the fuel cell stack 310. In this way, the coolant is more effective at its function of heat removal.

The oxygen is delivered via the oxygen portion 308 of the system 300. The oxygen delivery to fuel cell stack 310 enables fuel cell stack 310 to operate at a higher power output than when using only ambient air or the like, which has a lower percentage of oxygen (as in FIG. 2). The oxygen supply 314 therefore provides additional oxidant to the fuel cell stack 310 to provide additional power. The oxygen supplied to the fuel cell stack 310 can be supplied at a lower temperature than air. This leads to the fuel cell stack 310 requiring less cooling to achieve the same power. In turn, this leads to a mass saving, as less balance of plant (BoP) is required to achieve an equivalent power as for the fuel cell stack of FIG. 2. As such, in this arrangement 300, the fuel cell stack 310 provides greater power output than the fuel cell stack 210 in the arrangement 200 of FIG. 2.

The system 300 may be used in two modes—one where the fuel cell stack 310 is supplied with oxygen and one where the fuel cell stack 310 is not supplied with oxygen. In the first mode, the fuel cell stack 310 operates on oxygen and the system 300 provides a large amount of power. In a second mode, the fuel cell stack 310 is operated without oxygen. This second mode provides a lower amount of power than the first mode of operation. As such, this system 300 provides an arrangement for a fuel cell propulsion system that can controllably provide different levels of power, which may be chosen by an operator or by a controller based on environmental conditions. The system 300 therefore is well suited for use in a mode of transport that may require additional power during different portions of travel, such as an aircraft, which requires additional power during take off and does not require this power during cruise. This can be enabled by a simple closing valve or similar system to controllably prevent oxygen flowing from the oxygen source 314 to the fuel cell stack 310.

It is possible in the arrangement 300 shown in FIG. 3 to make turbine 324 not do much work, which will leave more energy in exhaust flow. If enough energy is left in the exhaust flow, which can be controlled by a user controlling the behaviour of turbine 324, this excess energy may drive the turbine 352 and subsequently operate compressor 356. This is a particularly energy efficient operating arrangement. This operating arrangement takes advantage of the pressure of effluent exiting the first turbine 324 and the ambient pressure. As such, this operational arrangement is particularly advantageous when system 300 is at altitude. In a method of operation of FIG. 3, turbine 324 is bypassed by the flow so as to leave sufficient energy in the exhaust flow to power turbine 354. In an alternate arrangement of FIG. 3 (not shown), the turbine 324 may be omitted.

In FIG. 3, the motor/generator 322 may be omitted if the shaft between the turbine 324 and the compressor 320 can still be operated. There would be associated weight gains with the omission of this motor/generator 322. While in FIG. 3, the motor/generator 252 from FIG. 2a is omitted, in an alternate arrangement, the motor/generator 222 may be omitted and the motor/generator 252 included.

While not explicitly shown, the systems described herein may include a regulating element such as a controller or the like, which regulates the water, hydrogen, oxygen and air being supplied from the supplies to the fuel cell stack and gas generator. The regulation may occur according to the power and cooling requirements of the fuel cell stack and the gas generator. This regulation may include feedback sensors or detectors for reading properties of the fuel cell stack and gas generator.

In use, hydrogen is provided to gas generator 350 to provide kinetic energy from chemical energy. To further improve efficiencies, unspent hydrogen that is provided to the fuel cell (which in practice can be between 0.1% to 5% hydrogen) can be recycled to the generator 350. This improves the overall efficiency of the propulsion arrangement. The 0.1% to 5% value stems from the anode stoichiometry of typical fuel cells, which results in purging of small quantities of hydrogen during fuel cell use. Many systems merely provide this into exhausts with air dilution sufficient to avoid dangerous chemical make up. The present system may reduce the risk of such an arrangement and improve the overall propulsive output by redirecting the hydrogen into the generator 350.

Alternatively or additionally, the hydrogen could be captured and stored prior to use (which may be in the generator 350 or back into the fuel cell). This arrangement therefore reduces the emission of gases into the atmosphere while also improving the output of the present arrangement. These advantages stem from the recapturing of non-spent hydrogen, which may also be referred to as purged hydrogen capture.

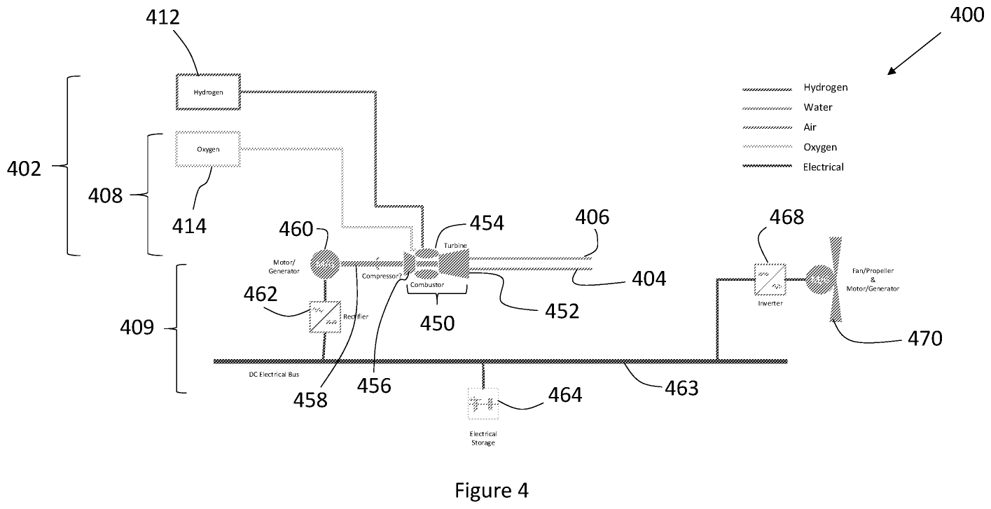

Referring now to FIG. 4, there is shown a battery electric range extender 400 for use in an aircraft propulsion system. Reference numerals for similar components of battery electric range extender 400 will be those as used in FIG. 3 with the numeral increased by 100. For expediency, a full description of similar components may not be provided.

Battery electric range extender 400 comprises a water line 406 supplying water from a water source, an air line 404 supplying air from an air source, a hydrogen source 412, an oxygen source 414, a gas generator 450 connected by a shaft 458 to a motor/generator 460 which is connected to a rectifier 462. The rectifier 462 supplies an electrical bus 463 which is connected to the electrical storage 464 and inverter 468 of previous arrangements. In this example of a battery electric range extender 400, the gas generator 450 is not mechanically linked to the fan 470. The generator 450 and the fan 470 may be linked by a gear box (which may be magnetic) or mechanically linked on the same shaft.

Furthermore, the electrical bus may not be needed for use in the arrangement, however modern aircraft use secondary aircraft power loads to provide electricity to other services on the aircraft, or for example to connect with a hybrid propulsion system, to enable operation of other aircraft components. This may enable one part to operate without the other or vice versa.

The arrangement 400 may be applied to an aircraft propulsion system to provide an additional power unit for providing propulsion to an aircraft. In effect, this is an add on that can significantly increase the power output and therefore the range of an aircraft, if desired, at a relatively cheap weight and fuel cost. As such, this provides an effective and efficient way to provide additional thrust to an aircraft.

Any system already containing hydrogen and oxygen sources can have the battery range extender 400 applied. Therefore, there is an advantage in the relatively simple application of this arrangement 400 to a propulsive arrangement of an aircraft for the provision of additional propulsive output.

The arrangements described herein can be applicable to short flight operations, such as electrical Vertical Take Off and Landings by using the pure oxygen and hydrogen gas turbine as a range extender for a solution that only uses a battery, or similar storage device, as an electric solution (also known as electrical energy storage device solution) or for creating peak power such that the batteries do not need to be high C-rate (C-rate is a measure of the rate at which a battery is discharged relative to its maximum capacity) for take off.

Using approximations, it is possible to calculate how to provide energy from these disclosed propulsive arrangements for flight conditions. In an example, for a regional aircraft with 8 MW take off peak power this could be provided by around 3 MW gas generator power using 4 MW fuel cell stack at 125% rating (overrating of a fuel cell being possible for a time without significant degradation of the fuel cell). The 4 MW fuel cell stack output is the rating approximately required for cruise. Therefore, the arrangement may be such that the fuel cell stack operates for cruise and the additional boost for take off and climb is provided by the 3 MW gas generator and overrating the fuel cell stack of a limited time period.

Continuing estimations in this particular example, the amount of hydrogen and oxygen consumed, during take off and climb period, would be approximately 13 kg and 52 kg respectively within the gas generator. An amount of 9 kg and 36 kg is further required in order to enable aborted landings and deviation (as discussed above). One advantage of this arrangement therefore is that this weight is largely consumed during takeoff and climb rendering the system lighter and therefore less thrust intensive during cruise.

The same approach could be applied to Brayton or Otto cycle engines as well as hybrid constant volume combustion cycle engines. As a benefit of the integrated motor/generator it can be used to reduce motor/lock or bow, enable start/restart as well support transient performance. Motor/lock or bow can occur from the subsequent cooling of elements (such as the shaft) after use of the arrangement generates large amounts of thermal energy.

The oxygen may be sourced from either a gas hydrogen system, liquid oxygen system or from an oxygen separation system (e.g. molecular sieve oxygen concentrator (MSOC), or on-board oxygen generation system (OBOGS) or Cryogenic Vortex Tube type system as examples). The air used as the source of this oxygen could be either cabin, environment control systems or external atmospheric air. The aim is to provide an increased oxygen percentage air supply, with advantages (explained above) increasing as the percentage of oxygen increases.

The sources in the systems presented herein include hydrogen and oxygen. The conditions of these sources are important to control to enable reliable delivery of the hydrogen and oxygen during operation of the system. To achieve suitable inlet pressures for this arrangement, the arrangements may include: high pressure tanks, removing the requirement for pumps/compressors; or, low pressure tanks with turbo-pumps.

As such, taking the above into account, a specific example of an implementation of the arrangements shown herein may include two space rocket style turbo-pumps (one for the oxygen source and one for the hydrogen source) feeding a combustor which drives a turbine which, in turn, drives the electrical generator. Alternatively, one combined space rock style turbo-pump may be used to provide compression to both sources.

There are a number of variations in the potential for this system which include driving generators from the turbo-pump turbines (thereby reducing the number of parts present in the system). Reducing the number of parts will increase the lifetime and reliability of the system as there are fewer parts to break down (impacting reliability) or require replacing (impacting lifetime).

The turbo-pumps as described above may be electrically driven or driven using steam from the system.

Additional elements to provide additional levels of control for a user may be introduced to the systems described herein without removing the advantages associated with the systems. For example, clutches and gearboxes may be used to enable greater control over the activation and deactivation of various components of the systems. Gearboxes may enable the user to control the each component of the arrangement to run at an optimal speed.

For example, when the aircraft is at sea level (or similar) air pressure such that the fuel cell is experiencing a higher level of pressure than, e.g., during flight. At sea level, there may be no requirement to compress the sources to the fuel cell stack and therefore providing a user with the option of deactivating these components is advantageous and, as a result resulting, provides a more efficient system (by virtue of the removal of activation of unnecessary elements in the arrangement). At sea level, for example, we can switch off aspects of the arrangement to increase the effectiveness of the overall arrangement. This decoupling therefore provides additional control and efficiencies for a user.

As such, there are arrangements provided wherein performance-controlling elements such as a clutch or a gearbox or the like may be included so as to provide the user with a greater control over the components of the arrangements. The performance-controlling elements may be mechanical or electrical elements that can impact operation of some of the components within the various arrangements shown in examples in the Figures herein. Controlling the operation of such components may allow a user to optimize the operation of the arrangement as a whole to provide efficiency gains (e.g. at low altitude wherein fewer components need to operational) or to provide additional thrust (e.g. at high altitude wherein the additional components may be activated). Controlling the operation of a component may include controlling whether a component is either activated or not activated, or the conditions of operation of that component (e.g. operational speed or the like).

Selection of the relative size of the components, such as the two compressors in the arrangements of FIGS. 2 and 3, may enable a weight saving to be provided within these arrangements. A consideration is the power output from the sizes of the compressors and balancing these accordingly.

In an arrangement, there may be an air filter between the air intake and the compressor. In a use example, the air filter may be switched in and out of activation with any available compression. This advantageously may reduce the amount of pollutants that are able to reach the fuel cell system of the arrangements. However, across the air filter there will be a pressure loss. As such, there is a balance to make between filtering the air to reduce the amount of pollutants reaching the fuel cell system and increasing the pressure loss through the air filter.

In such an arrangement, the user may capitalise on switching the gas flow path at sea level compared to that at altitude. In particular, because, at altitude, air is typically cleaner than at sea level. As such, there is a reduced need for filtration at altitude. In this way, an arrangement, with an air filter that can be user activated and deactivated, offers greater control to the user in terms of enabling filtration but bypassing the air filter when operating at altitude. Accordingly, there is both an efficiency gain (in not permanently using the airflow path with the air filter) while also providing an improved lifetime gain due to the reduced levels of pollutants reaching the fuel cell stack.

Therefore, there is described herein an effective and fuel efficient propulsion system. This system provides a number of advantages as discussed above. Further advantages include, in the use of hydrogen and oxygen, the only by products are deionized superheated steam and water fluid: no nitrous oxide. This system uses the high power density of the gas generator whilst overcoming the issue of contrails by operation largely at less than 20-25,000 feet.

Oxygen is eight times heavier than hydrogen and four times in the reaction to water, as such it is not viable to use oxygen for the entire flight as even though hydrogen is ⅓ the mass of Kerosene (up to ⅔ installed) with oxygen, the fuel and oxidant mass (not installed), would be around 150% more than for Kerosene alone. However, in the case oxygen is used to provide the peak power it is required for a maximum of around 500 seconds for any aircraft operation.

This includes around 300 seconds of takeoff and climb, around 3 aborted landings and around one climb out in case of a deviated landing.

The use of pure oxygen and hydrogen enables a substantially smaller (more power dense) and lighter mass (higher specific power) gas generator as indicated in above. Use of liquid hydrogen and oxygen (i.e. as cryogens) also provide advantages in power density and cooling factors.

Although the fuel cell propulsion systems disclosed have mostly been described in terms of aircraft, other vehicles such as spacecraft and submarines or the like may carry oxygen or liquid oxygen for use in the proposed systems (in place of the air intake or ECS supply). Although, this oxygen or liquid oxygen may be carried primarily for other reasons, integration of additional oxygen for use in the fuel cells of the presently disclosed systems would not be mechanically intensive. Alternatively, or additionally, these vehicles might advantageously be arranged to provide excess oxygen or liquid oxygen to a fuel cell propulsion system as described herein. As such, the disclosed systems would be advantageously provided in such vehicles. Any vehicle which might be propelled by a fuel cell propulsion system such as that described herein would benefit from use of the systems disclosed herein.

The system disclosed herein might be advantageously used to provide propulsion in a vehicle or system which may benefit from a system that can provide a controllably variable amount of propulsion across a wide range of propulsion values, provided by the fuel cell system that can operate in both normal and overrated mode as well as the additional power provided by the gas generator.

Numerous advantages are provided by a production of power from fuel cells rather than say via combustion engines. The production of water in place of harmful gaseous emissions (NOx, CO2 etc) has clear associated advantages. Furthermore, operation of the vehicle can occur with significantly reduced noise levels. In a particular example, take off and landing phases for aircraft can occur with significantly reduced noise levels due to the lack of high velocity exhaust gas.

Provision of additional selectable thrust (from the gas generator) can also be used by the operator of the vehicle whenever desired. This flexibility would enable a pilot to optimise the thrust choice for the stage of flight or motion (e.g. a race car along a straight). These systems may also not restrict an operator to a particular fuel cell stack if, for example, a change in thrust is desired at any stage in a flight to overcome, or adapt to, changes in flight conditions.

Applications for this system therefore may include automotive, space, domestic or commercial and so forth.

A further benefit of the use of fuel cells over combustion engines as disclosed herein is that microbe colony formation which occurs in existing aircraft kerosene fuel tanks is avoided. The cleaning of such tanks currently requires detergent insecticide cleaners that are somewhat environmentally damaging. In some cases this cleaning may be after each long haul flight. Therefore, the reduction in cleaning has further environmental benefits.

Disclosed herein is a propulsion system. The propulsion system has a fuel cell system comprising features as shown in previous figures, such as fuel cell stacks. An air supply feeds the fuel cell system. A liquid hydrogen supply provides liquid hydrogen to the fuel cell system including the fuel cell stack. In an example, not shown, the system may also comprise a helium loop. The helium loop may comprise a helium supply to supply helium and a conduit. The helium loop may be arranged to provide additional cooling for specific portions of the propulsion system. Such portions may include the electric conducting portions and the motor/generator.

In an example, the liquid hydrogen interacts with helium from the helium supply. The liquid hydrogen may cool the helium and become gaseous hydrogen. The gaseous hydrogen may then be provided into the fuel cell stacks or the like for use in production of electrical energy.

The fuel cell system provides electrical energy in the form of a direct current. The fuel cell system also provides air and water as well as thermal energy in the form of heat. The electrical energy from the fuel cell system may be provided into a network controller. The current may then be provided to a motor and generator arrangement to provide kinetic energy from the electrical energy to a propulsor for providing motion.

The helium in the helium loop is cooled by the liquid hydrogen. The cooled helium can then provide cooling on direct items such as electrical connections providing electrical energy from a network controller to the motor and generator arrangement. The cooled helium can also provide cooling to the motor and generator arrangement itself. Helium is advantageous in such a system as it has a lower melting point than hydrogen and therefore can be cooled by hydrogen without danger of freezing in the conduits holding the helium. Other cryo coolants may be used, however helium is particularly advantageous.

1. A propulsion system for providing controllable propulsion comprising:
a fuel cell arrangement for generating electrical energy;
a gas generator comprising a compressor, a combustor and a turbine, wherein the output from the turbine is arranged to provide propulsion from rotational movement;
a hydrogen source for providing hydrogen to the fuel cell arrangement and the gas generator;
an oxygen source for providing oxygen to the gas generator,
wherein, in use, the gas generator is used selectively to provide electrical energy for additional propulsion.

2. A propulsion system according to claim 1, wherein the oxygen source is further arranged to provide oxygen to the fuel cell arrangement.

3. A propulsion system according to claim 1, further comprising:
a motor/generator connected to the gas generator;
a rectifier electrically connected to the motor/generator;
a propeller for providing propulsion from rotational movement;
an inverter electrically connected to the rectifier and the propeller; and
an electrical bus electrically connecting the rectifier and the inverter,
arranged so that the electrical output of the motor/generator connected to the gas generator is converted by the rectifier then converted by the inverter prior to being provided to the propeller.

4. A propulsion system according to claim 3, further comprising a converter electrically connected to the electrical bus and to the fuel cell arrangement, the converter arranged to convert the electrical output of the fuel cell arrangement prior to the electrical output of the fuel cell arrangement being received by the inverter.

5. A propulsion system according to claim 1, further comprising electrical energy storage electrically connected to the fuel cell arrangement and the gas generator, the electrical energy storage arranged to store electrical energy output by the gas generator and the fuel cell arrangement.

6. A propulsion system according to claim 1, further comprising:
a water arrangement for providing fluid communication of water between a water store and the fuel cell arrangement and the gas generator; and
an air arrangement for providing fluid communication of air between an air inlet and the fuel cell arrangement and the gas generator.

7. A propulsion system according to claim 1, wherein the hydrogen source and the oxygen source are in a closed loop system within the propulsion system.

8. An aircraft comprising the propulsion system according to claim 1.

9. An electric power range extender for providing electrical energy comprising:
a gas generator;
a hydrogen source for providing hydrogen to the gas generator; and
an oxygen source for providing oxygen to the gas generator,
the gas generator being arranged in use to selectively use hydrogen and oxygen from the hydrogen source and the oxygen source to generate electrical energy.

10. An electric power range extender according to claim 9, further comprising:
a motor/generator connected to the gas generator;
a rectifier electrically connected to the motor/generator;
an inverter electrically connected to the rectifier; and
an electrical bus electrically connecting the rectifier and the inverter,
arranged so that the electrical output of the motor/generator is converted by the rectifier, travels along the electrical bus, and is then converted by the inverter.

11. An electric power range extender according to claim 9, further comprising electrical energy storage electrically connected to the gas generator, the electrical energy storage arranged to store electrical energy output by the gas generator.

12. An electric power range extender according to claim 9, wherein the hydrogen source and the oxygen source are in a closed loop system within the electric power range extender.

13. An electric power range extender according to claim 9, further configured to connect to an aircraft propulsion system.

14. An aircraft comprising the electric power range extender according to claim 9.

15. A method of generating propulsion comprising:
providing hydrogen from a hydrogen source to a fuel cell arrangement to produce an electrical energy output;
providing the electrical energy output of the fuel cell arrangement to a propeller to generate propulsion;
selectively providing hydrogen from a hydrogen source and oxygen from an oxygen source to a gas generator to selectively produce an electrical energy output; and
selectively providing the electrical energy output of the gas generator to a propeller to generate propulsion.

16. A method of generating propulsion according to claim 15,
wherein the selectively providing the hydrogen from the hydrogen source and the oxygen from the oxygen source to the gas generator is based on a predetermined propulsion-requiring travel condition.

17. A method of generating propulsion according to claim 16, wherein the predetermined propulsion-requiring travel condition is a take off and climb portion of a flight of an aircraft.

18. A method of generating propulsion according to claim 15,
wherein the selectively providing the hydrogen from the hydrogen source and the oxygen from the oxygen source to the gas generator to selectively produce the electrical energy output is based on a predetermined non-propulsion-requiring travel condition;
wherein the electrical energy output of the gas generator is provided to electrical energy storage for storage.

19. The method of claim 15 used in an aircraft.
